(19) United States
(12) Patent Application Publication
(10) Pub. No.: US 2025/0129666 A1
(43) Pub. Date: Apr. 24, 2025

(54) VERTICAL BLIND COMPRISING MULTIPLE STRIP-SHAPED SHADING ELEMENTS

(71) Applicant: Hunter Douglas Industries Switzerland GmbH, Luzern (CH)

(72) Inventors: Nadine FÄRBER, Hagen (DE); Guido TANTS, Midlum (DE); Wolfgang ZWENGER, Bremerhaven (DE); Jens WÜNSCHE, Bremerhaven (DE)

(21) Appl. No.: 18/691,518

(22) PCT Filed: Sep. 13, 2022
(86) PCT No.: PCT/EP2022/075432

§ 371 Date: Mar. 13, 2024

(30) Foreign Application Priority Data
Sep. 14, 2021 (DE) 10 2021 123 763.7

(51) Int. Cl. E06B 9/36; E06B 9/24; E06B 9/262

(52) U.S. Cl. CPC E06B 9/364; E06B 9/262; E06B 2009/2405; E06B 2009/2488

(57) ABSTRACT

A vertical blind (10) includes a plurality of strip-shaped vertically arranged shading elements (14, 15) which are held in pivot hooks (18) pivotable about a vertical axis. Two shading elements (14, 15) are arranged in each case on mutually remote longitudinal sides of a strip-shaped intermediate element (16) and together with the latter form a blind element (12). Easy assembly and disassembly of the shading elements (12) can be achieved by the fact that multiple blind elements (12) are provided separated from one another. Shading elements (14, 15) adjacent to one another are held by a common swivel hook (18). The swivel hook (18) has a receiving device (21) for the two adjacent shading elements (14, 15).

### CROSS REFERENCE TO RELATED APPLICATIONS

This application is a United States National Phase Application of International Application PCT/EP2022/075432, filed Sep. 13, 2022, and claims the benefit of priority under 35 U.S.C. § 119 of German Application 10 2021 123 763.7, filed Sep. 14, 2021, the entire contents of which are incorporated herein by reference.

### TECHNICAL FIELD

The invention relates to a vertical blind with a plurality of strip-shaped vertically arranged shading elements which are held in swivel hooks that can be swiveled (are pivotable) around a vertical axis, wherein two shading elements are each arranged on opposite longitudinal sides of a strip-shaped intermediate element and together with the latter form a blind element.

### BACKGROUND

Vertical blinds are used to shade building openings. For this purpose, multiple strip-shaped shading elements, so-called vertical slats, are arranged vertically. They can be moved horizontally so that they are evenly distributed horizontally along a building opening, in particular a window. To provide shade, these vertical slats can then be pivoted around their vertical longitudinal axis, effectively preventing light from entering. In this way, indirect light can be brought into the building envelope in offices, while direct glare is avoided. It is also possible to close the vertical blinds completely and thus minimize light entering through the building opening.

Such vertical blinds allow the use of a variety of curtain materials for the vertical slats. However, the somewhat futuristic appearance, which differs significantly from classic curtains or drapes, is often perceived as disruptive, particularly in private households. For this purpose, curtain elements (hanging elements) have been developed for vertical blinds, each of which has an intermediate element between two shading elements. These curtain elements are then connected to adjacent shading elements in a quasi-U-shape, so that a curtain-like appearance results both when closed and when open. For this purpose, the adjacent shading elements of different curtain elements are glued together, sewn together or provided with a common clip for suspension in their upper fastening area.

The disadvantage of this is that it results in a relatively large, difficult-to-handle curtain that is difficult to assemble and disassemble, especially for installation and removal. In particular, the entire curtain material must be held at once, while one suspension clip after the other must be inserted into the corresponding swivel hook. If damaged or soiled, the entire curtain material must be removed in one piece.

### SUMMARY

An object of the invention is to provide a vertical blind with which a curtain-like overall appearance is achieved, whereby assembly and disassembly is simplified and, if individual curtain elements are soiled or damaged, they can be replaced separately without having to remove the entire curtain material.

The problem is solved in a vertical blind of the above-mentioned type in that a plurality of separate curtain elements are provided, in that adjacent shading elements of adjacent curtain elements are held by a common swivel hook, and in that the swivel hook has receiving means (with a retaining device or mounting device) for receiving the two adjacent shading elements.

In this way, the curtain elements can be removed or inserted individually by removing their two edge-side shading elements from their respective receiving means. It is not necessary to insert or remove the entire curtain material at once. In addition, the solution according to the invention offers the advantage that individual curtain elements can also be subsequently replaced, for example to achieve a different visual impression.

A further development of the invention is characterized by the fact that the common swivel hook is configured to connect the adjacent shading elements to one another, with the receiving means preferably having a common receptacle or separate receptacles for the adjacent shading elements. In this way, the curtain material is only produced as a whole when the individual curtain elements are joined together in the respective receptacles provided for the swivel hooks.

Another further development of the invention is characterized by the fact that the receiving means have at least one hook with a retaining section (holding section or mounting section) for the adjacent shading elements, preferably a retaining section for each shading element. A common retaining section has the advantage of particularly simple and material-saving manufacture. For installation, first one shading element and then the other shading element must be inserted into the holder. In the alternative with two separate holders, insertion and removal can be carried out as required, as each shading element is assigned its own holder.

According to the invention, it is also advantageous that the hook is assigned a guide means, preferably of resilient (spring) configuration, for guiding the shading element to the retaining section and for securing the shading element thereto, preferably the hook has the guide means. In this way, the shading element can be securely fastened to the retaining section. The guide means make it easier to attach the shading element to the retaining section. In this way, it is virtually impossible for the shading element to accidentally slip out of the retaining section. A resilient configuration is particularly advantageous, as in this case it would only be possible for the shading element to accidentally slip off the retaining section against the spring action.

Another further development of the invention is characterized by the fact that the guide means is a spring tab which has a stop, in particular a resilient (spring loaded) stop, for limiting the insertion path of the shading element into the holder. This results in a particularly simple structure, whereby a reliable securing of the shading element is achieved in particular with the resilient stop. In another embodiment of the invention, the swivel hook is guided for movement along an upper rail. In this way, the curtain material can be positioned in front of a building opening to be shaded. However, it is equally possible to move the curtain material to the side to achieve an unobstructed view.

Another embodiment of the invention is characterized by the fact that the shading elements have greater rigidity than the intermediate elements, with the shading elements preferably being configured to provide more shade than the intermediate elements, in particular to be light-tight (light impermeable-a light barrier). The greater rigidity means that the shading elements can be guided securely in their open or closed position by the swivel hooks, while the intermediate elements move out of the way accordingly. If the shading elements are also configured to provide more shade than the intermediate elements, in particular to be light-tight, the result is a pleasing appearance similar to a conventional curtain.

In a further development of the invention, it is also advantageous that the intermediate elements are connected along their longitudinal edges to the adjacent shading elements, preferably sewn, glued or welded to them, and in particular are formed in one piece with them. This effectively prevents the intermediate elements and the shading elements from getting mixed up, for example due to a gust of wind, so that their pleasing appearance can be maintained.

Another embodiment of the invention is characterized by a drive for moving and/or swiveling the swivel hooks, in particular a motor, a ball chain and/or a sling bar gear. This results in simple operation.

In the following, an embodiment of the invention is explained in more detail with reference to the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic perspective view of a vertical blind with the features of the invention;

FIG. 2 is an enlarged partial view of multiple blind element with curtain elements guided on a rail as seen from below;

FIG. 3 is an enlarged partial representation of the arrangement of adjacent shading elements on a swivel hook;

FIG. 4 is an enlarged partial representation of the swivel hook of FIG. 3 with the shading elements removed; and

FIG. 5 is a perspective view of a carriage of the vertical blind of FIG. 1 with a swivel hook arranged in the carriage.

### DESCRIPTION OF PREFERRED EMBODIMENTS

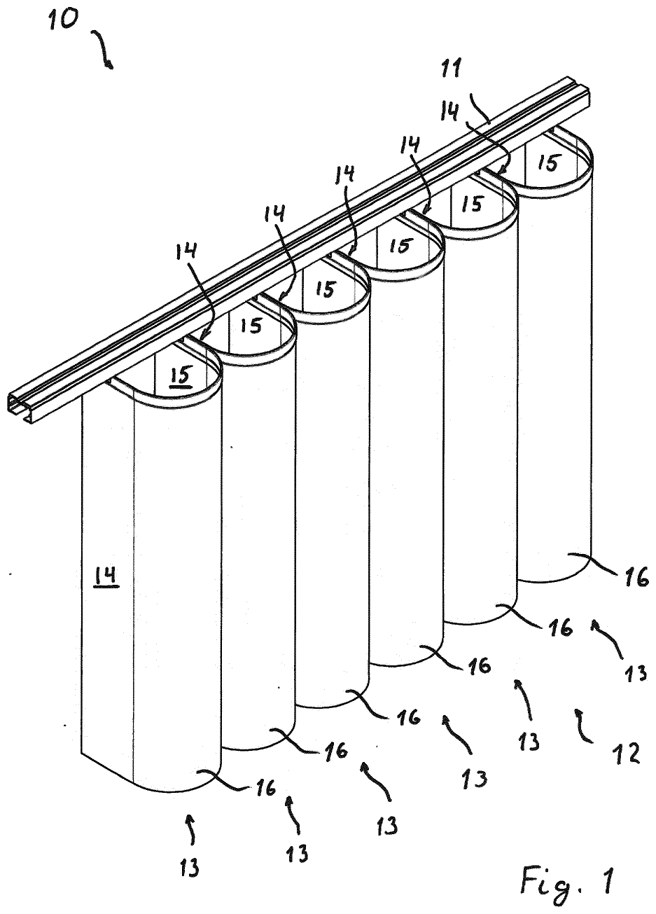

Referring to the drawings, FIG. 1 shows a schematic representation of a vertical blind 10 as an embodiment of the invention in a perspective view. A rail 11 attached to a ceiling or soffit not shown in the figure carries the blind 12 of the vertical blind 10.

As can be seen from the figure, the blind 12 has multiple curtain elements 13, each of which has shading elements 14, 15 with intermediate elements 16 arranged between them.

The shading elements 14, 15 are elongated and strip-shaped. They are also formed of a flat material. In the exemplary embodiment shown, the shading elements are light-tight. Between the shading elements 14, 15 of a curtain element 13, the associated intermediate element is firmly connected to the shading elements 14, 15 via the common longitudinal extension. In the present case, the shading elements 14, 15 are formed in one piece with the respective intermediate elements 16, namely woven together. The shading elements 14, 15 are more densely woven than the intermediate elements 16. In this way, in the open state of the shading elements 14, 15 shown, light can pass through the intermediate elements 16, whereas in a closed state, in which the shading elements are swiveled (pivoted) approximately parallel to the rail 11, no light can pass through and good shading is achieved.

As can also be seen from the figure, the curtain elements 13 are approximately U-shaped in cross-section, with the shading elements 14, 15 forming the U-legs and the intermediate elements 16 forming the U-shaped curve in the state shown.

Adjacent shading elements 14, 15 of adjacent curtain elements 13 come to lie against each other in the arrangement shown. However, the adjacent shading elements 14, 15 of adjacent curtain elements 13 that come to lie against each other are not firmly connected to each other, such as glued, sewn, pressed or clipped together. Instead, the various curtain elements 13 are interchangeably held individually removable with their respective shading elements 14, 15 in swivel hooks not shown in the figure.

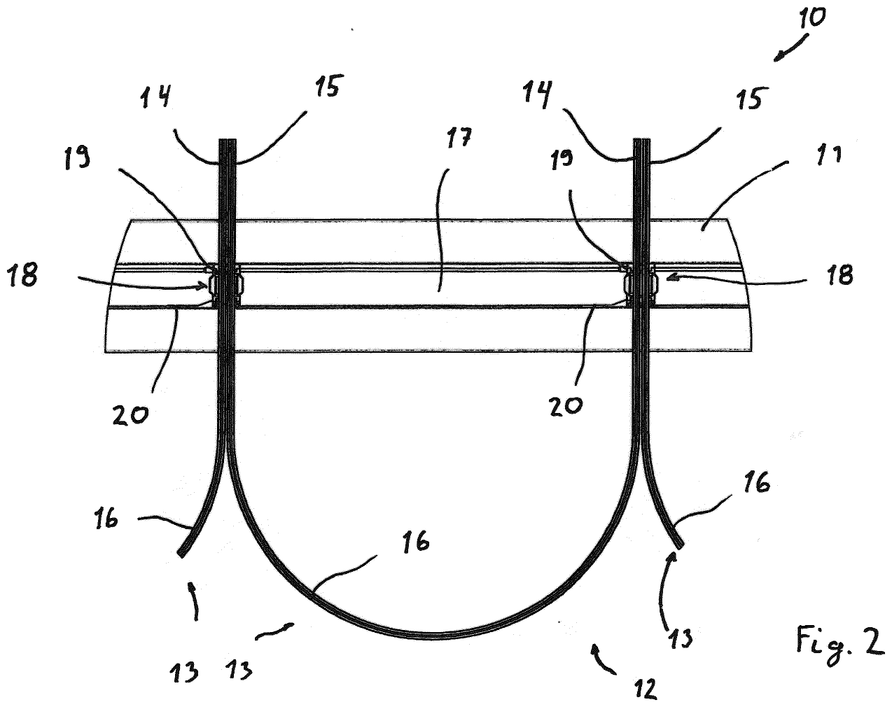

FIG. 2 shows an enlarged partial view of the vertical blind 10 of FIG. 1 as seen from below. It can be seen that the adjacent shading elements 14, 15 of adjacent curtain elements 13 come to rest against each other. As can be seen from the figure, the adjacent shading elements 14, 15 lying next to each other are held in a common swivel hook 18, so that they are secured in their position.

The swivel hook 18 is guided in a groove 17 of the rail 11 by means of a carriage 19. Furthermore, the carriage 19 has a guide bar 20 to stabilize the groove 17, as will be explained in more detail below.

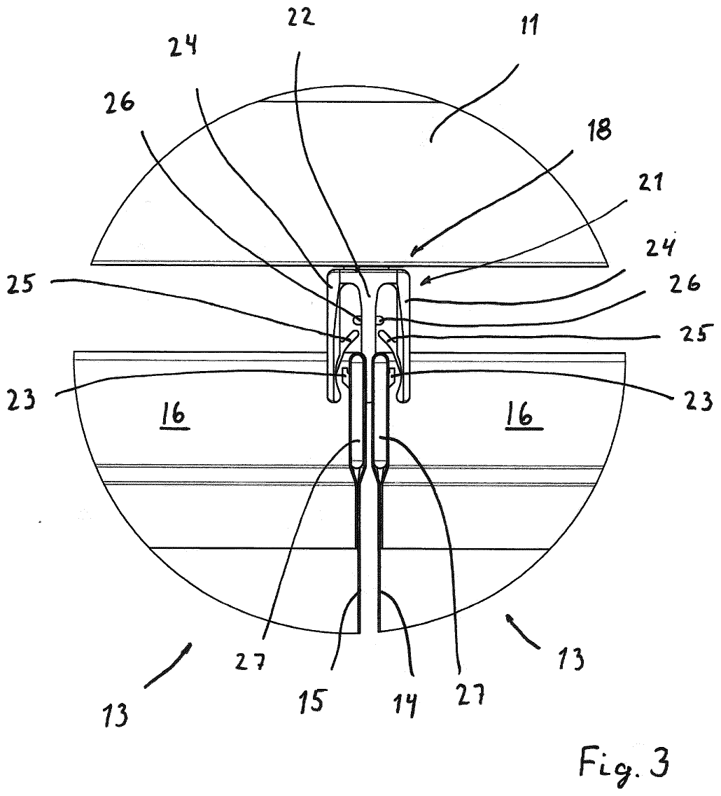

FIG. 3 shows an enlarged partial representation of the vertical blind 10 with shading elements 14, 15 individually removably attached to the swivel hook 18. As can be seen from the figure, the swivel hook 18 has receiving means for the shading elements 14, 15. Specifically, the receiving means 21 have a hook 22 which has retaining sections 23 for the shading elements 14, 15. Specifically, in the embodiment example shown, the hook 22 is configured as a double hook and has two retaining sections 23 assigned to each of the two shading elements 14, 15.

Guide means 24 are provided associated with the retaining sections 23. In the embodiment example shown, the guide means 24 are configured as guide tabs 24 and each have a stop 25 adjacent to the retaining sections. In the embodiment example shown, the stops 25 are resilient (spring loaded), as are the guide means 24.

The hook 22 also has stops 26 facing the guide means 24 and the stops 25, which are configured as projections in the embodiment example shown. The hook 22, the guide means 24, the stops 25, 26 and the retaining sections 23 are firmly connected to one another in the embodiment example shown, namely are formed in one piece.

As can also be seen from the figure, the shading elements 14, 15 have pockets for webs 27 in their upper area. In the embodiment example shown, the webs 27 are made of a rigid material. The webs 27 are used to arrange the shading elements 14, 15 in the retaining sections 23.

To attach the shading elements 14, 15 to the swivel hook 18, the webs 27 arranged in the pockets of the shading elements 14, 15 are each positioned in the area between the retaining sections 23 and the guide means 24 and then pushed upwards in the figure against the spring action of the guide means 24. The stops 25, 26 prevent the webs 27 from being pushed too far upwards in the figure. For fastening, the webs 27 with openings not shown in the figure are then pushed over the retaining sections 23, whereupon the guide means 24 spring back. In this way, the shading elements and thus the corresponding curtain elements 13 are reliably attached to the swivel hook 18.

To remove them, the individual shading elements 14, 15 must then be pushed upwards again in reverse order to allow the guide means 24 to spring back. In this state, the webs 27 can then be guided back downwards past the retaining sections 23 in the figure.

It is also possible to use a common, correspondingly larger hook 22. In this case, the outer shading element 14, 15 would first have to be removed in order to remove the inner shading element 14, 15. In this case, it is still easy to remove individual curtain elements.

FIG. 4 shows an illustration similar to FIG. 3 with the curtain elements 13 removed. Identical elements bear the same reference symbols. This figure shows the specific design of the retaining sections 23. According to this, the retaining sections 23 are configured similarly to barbs or a stick anchor. This ensures a secure hold.

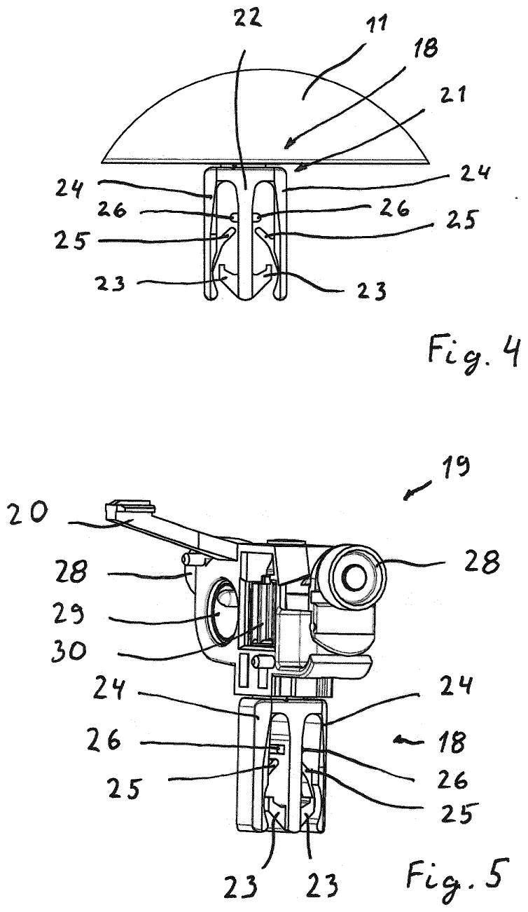

FIG. 5 shows a perspective view of the carriage 19 with swivel hooks 18 arranged thereon. As can be seen from the figure, the carriage 19 has rollers 28. In the embodiment example shown, two rollers 28 are provided on opposite sides of the carriage 19. In addition, the carriage 19 has a swivel gear, consisting of a receptacle 29 and a gearwheel 30. The receptacle 29 serves to receive a grooved shaft, by means of which a rotary movement of the grooved shaft is transmitted to the receptacle 29 and thus to the worm gear surrounding the receptacle, which is not shown in this embodiment. By means of this worm thread, which is not shown, the gearwheel 30 is driven, in which the swivel hook 18 is arranged in a rotationally fixed manner. This causes the swivel hook 18 to swivel when the gearwheel 30 is turned.

While specific embodiments of the invention have been shown and described in detail to illustrate the application of the principles of the invention, it will be understood that the invention may be embodied otherwise without departing from such principles.

### LIST OF REFERENCE CHARACTERS

10 Vertical blind
11 Rail
12 Blind
13 Curtain element
14 Shading element
15 Shading element
16 Intermediate element
17 Groove
18 Swivel hook
19 Carriage
20 Guide bar
21 Receiving means
22 Hooks
23 Retaining section
24 Guide
25 Stop
26 Stop
27 Web
28 Rollers
29 Receptacle
30 Gearwheel

1. A vertical blind comprising:
a plurality of strip-shaped, vertically arranged shading elements;
swivel hooks, wherein the shading elements are held in the swivel hooks to be pivotable about a vertical axis; and
strip-shaped intermediate elements, two shading elements being arranged in each case on mutually remote longitudinal sides of an associated one of the strip-shaped intermediate elements and the two shading elements, together with the associated strip-shaped intermediate element forming a blind element, wherein a plurality of mutually separate blind elements are provided, and wherein mutually adjacent shading elements of mutually adjacent blind elements are held by an associated common swivel hook, and wherein each of the associated common swivel hooks comprises receiving means for the two adjacent shading elements.

2. A vertical blind according to claim 1, wherein the common swivel hook is configured to connect the adjacent shading elements to one another, the receiving means comprising a common receptacle or separate receptacles for the adjacent shading elements.

3. A vertical blind according to claim 1, wherein the receiving means comprises have at least one hook with a retaining section for the adjacent shading elements.

4. A vertical blind according to claim 3, wherein the hook is assigned a guide means, for guiding the shading element to the retaining section and for securing the shading element thereto.

5. A vertical blind according to claim 4, wherein the guide means comprises a spring tab which has a stop, in particular of resilient configuration, for limiting the path of insertion of the shading element into the receiving means.

6. A vertical blind according to claim 1, further comprising an upper rail, wherein the swivel hook is guided to move along the upper rail.

7. A vertical blind according to claim 1, wherein the shading elements have a greater rigidity than the intermediate elements, the shading elements being configured to provide greater shading than the intermediate elements.

8. A vertical blind according to claim 1, wherein the intermediate elements are connected along longitudinal edges thereof to the adjacent shading elements.

9. A vertical blind according to claim 1, further comprising a drive for moving and/or swiveling the swivel hooks.

10. A vertical blind comprising:
a plurality of mutually separate blind elements, each of the blind elements comprising two vertically extending shading elements and a vertically extending intermediate element, wherein each of the two shading elements is connected to one of two spaced apart longitudinal edges of the intermediate element; and
swivel hooks configured to swivel about a vertical axis, each of the swivel hooks comprising a receiving device configured to receive two adjacent shading elements of two adjacent blind elements.

11. A vertical blind according to claim 10, wherein each of the swivel hooks is configured to connect the two adjacent shading elements to each other, wherein the receiving device comprises a common receptacle for receiving the adjacent shading elements or two separate receptacles for receiving the adjacent shading elements.

12. A vertical blind according to claim 11, wherein the receiving device further comprises a hook with a retaining section configured to retain the adjacent shading elements.

13. A vertical blind according to claim 12, wherein the receiving device further comprises a guide configured to guide the shading element to the retaining section and to mount the shading element to respective swivel hook.

14. A vertical blind according to claim 13, wherein the guide comprises a resilient tab with a stop configured for limiting a path of insertion of the shading element into the retaining section.

15. A vertical blind according to claim 10, further comprising an upper rail, wherein each swivel hook is guided to move along the upper rail.

16. A vertical blind according to claim 10, wherein the shading elements have a greater rigidity than the intermediate elements and the shading elements are configured to provide greater shading than the intermediate elements.

17. A vertical blind according to claim 16, wherein the shading elements each form a light barrier.

18. A vertical blind according to claim 10, wherein the two shading elements are connected to the longitudinal edges of the intermediate element by a sewn connection, a glue connection a weld connection or the two shading elements are formed in one piece with the intermediate element.

19. A vertical blind according to claim 10, further comprising by a drive for moving and/or swiveling the swivel hooks.

20. A vertical blind according to claim 19, wherein the drive comprises a motor, a ball chain and/or a centrifugal rod gear.
